(19) United States
(12) Patent Application Publication
(10) Pub. No.: US 2025/0320093 A1
(43) Pub. Date: Oct. 16, 2025

(54) UNIVERSAL LIFTING APPARATUS

(71) Applicant: Igor Chepets, Brooklyn, NY (US)

(72) Inventor: Igor Chepets, Brooklyn, NY (US)

(21) Appl. No.: 19/179,838

(22) Filed: Apr. 15, 2025

Related U.S. Application Data
(60) Provisional application No. 63/634,495, filed on Apr. 16, 2024.

(51) Int. Cl. B66F 3/00

(52) U.S. Cl. CPC B66F 3/005

(57) ABSTRACT

A lifting apparatus is disclosed that includes a first frame and a horizontally opposed second frame interconnected by at least one beam at their top portions. A lifting assembly is pivotally mounted to the beam between the frames and includes a lifting arm, a contact portion for engaging an object, and a lifting component. The contact portion is connected to the beam via the lifting component, which is also pivotally connected to the beam through the lifting arm. The configuration allows for selective actuation of the lifting arm to raise and lift an object independently of the vertical movement facilitated by the lifting mechanism, providing improved control and flexibility in lifting operations.

The present application claims priority to U.S. Provisional Patent Application No. 63/634,495, entitled “Universal Lifting Apparatus,” filed Apr. 16, 2024, which is incorporated herein by reference in its entirety.

### BACKGROUND

The present application relates to devices for lifting objects, such as hoists.

Several devices have been developed for lifting objects, such as jacks, hoists, cranes, etc. These devices, however, have specific uses and are not suitable for lifting light, yet cumbersome objects. One task that is not accounted for is the removal and installation of toilets and other fixtures. As of this writing, Applicant is not aware of any products that allow users to lift such objects within the normal confines that such objects are installed. Instead, plumbers must lift toilets by hand, for example, to replace the wax ring, and then place the toilet out of the way for the next task at hand. This poses a risk of injury to the plumber that must lift the object in a relatively confined space. Moreover, wastewater may potentially be spread outside of the immediate workspace, creating a hazard.

Accordingly, there is a need for a universal lifting device that is not so limited.

### SUMMARY OF THE INVENTION

In one aspect, a lifting apparatus is provided that includes a first frame and a second frame, the first frame horizontally opposed from the second frame; at least one beam interconnecting a top portion of the horizontally opposed first and second frames; and a lifting assembly coupled to the at least one beam, the lifting assembly comprising a lifting arm, a contact portion configured to engage an object to be lifted, and a lifting component, the contact portion functionally coupled to the at least one beam with the lifting component, the lifting component pivotally coupled to the at least one beam with the lifting arm, wherein actuating the lifting arm lifts and raises the object independent of the raising and lowering of the object with the lifting component.

In one embodiment, the at least one of the frames further includes wheels for facilitating movement of the apparatus.

In one embodiment, the frames, the strut and the beams are constructed from a material selected from the group consisting of steel and aluminum.

In one embodiment, each of the first and second frames comprises a plurality of legs pivotally coupled to a block, and a strut connecting the plurality of legs of each of the first and second frame to form an A-shape configuration.

In one embodiment, the lifting component comprises a threaded rod, a threaded collar, a contact portion coupled to the threaded rod, wherein a distal end of the lifting arm has a horizontal aperture and a vertical aperture, the at least one beam passes through the horizontal aperture, wherein the threaded rod passes through the vertical aperture, and wherein lifting of the contact portion is caused by threading the threaded collar to shorten an exposed length of the threaded rod.

In one embodiment, the contact portion comprises a horizontal member and a plurality of hooks pivotally coupled thereto.

In one embodiment, each hook comprises a vertical member.

In one embodiment, the hook portions further comprises blocks orthogonal to the vertical members.

Additional aspects of the present invention will be apparent in view of the description which follows.

### BRIEF DESCRIPTION OF THE FIGURES

The universal lifting apparatus may be more completely understood in consideration of the following detailed description of various embodiments of the invention in connection with the accompanying drawings, in which:

FIG. 1 is a perspective view of a universal lifting apparatus according to a preferred embodiment.

FIG. 2 is a partial sectional view of the apparatus according to a preferred embodiment.

While the universal lifting device is amenable to various modifications and alternative forms, specifics thereof have been shown by way of example in the drawings and will be described in detail. It should be understood, however, that the intention is not to limit the invention to the particular embodiments described but rather to include all modifications, equivalents, and alternatives.

### DETAILED DESCRIPTION

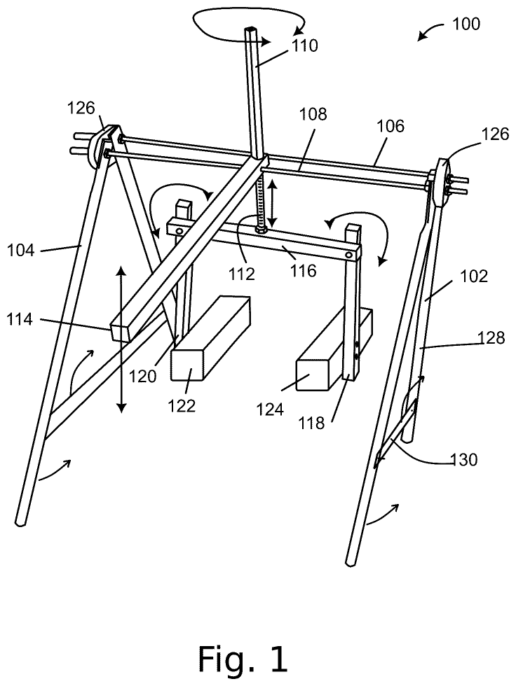

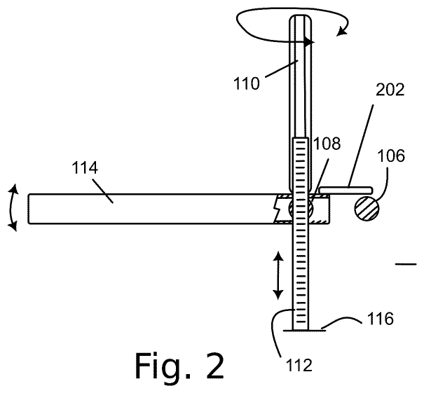

Referring to FIGS. 1-2, the universal lifting apparatus 100 according to a preferred embodiment generally includes a first frame 102 and a second frame 104, horizontally opposed (spaced laterally apart) and interconnected at the top end of the frames 102, 104 via at least one beam 109, 108. Preferably, each of the frames 102, 104 include a plurality of legs 128 pivotally coupled to a block 126. Preferably, the legs 128 pivot in a common plane to form a folding A-frame, as shown. The legs 128 of the frames 102, 104 may further be stabilized with a strut 130, which closes the generally A-shaped frame as shown for stability. The strut 130 may be pivotally coupled to one of the legs 128 of a respective frame 102 to allow the frame 102, 104 to be folded for storage. The frames 102, 104 may include wheels for moving the apparatus across the floor (not shown).

In one embodiment, the apparatus 100 includes a plurality of beams 106, 108, which includes a first beam 106 and a second beam 108. The beams may have a square, round, rectangular, I-beam cross section/shape, which may be tubular. Preferably, apparatus 100 includes a lifting assembly pivotably coupled to one of the beams 106, 108. That is, the lifting assembly pivots about a lengthwise axis of one of the beams 106, 108. The lifting assembly is generally a system that enables the apparatus 100 to lift objects vertically.

In one embodiment, the lifting assembly includes a lifting component 112, which is generally manipulated to lift and/or lower a contact portion 116 of the lifting assembly. In one embodiment, the lifting component includes a threaded rod 112 coupled to an internally threaded collar 110. In this regard, turning the threaded collar 110 clockwise or counterclockwise will cause the threaded rod 112 to draw into or extend out of the threaded collar 110 thereby lifting and lowering, respectively, the contact portion 116. The contact portion 116, generally connects to the lifting component 112 and provides a means for securing objects to the lifting apparatus 100 and more specifically the lifting assembly. This design allows the user to lift objects vertically with relative precision. Other mechanisms may also be used to provide fine or precise lifting of the lifting component 112, including hydraulic lifts, scissor jack assemblies, etc., each connected to the contact portion 116 for lifting objects as discussed herein.

In one embodiment, the contact portion 116 includes a horizontal member coupled to the lifting component 112, with a plurality of hooks 118, 120, 122, 124 pivotally coupled to the horizontal member. The hooks generally include a vertical member 118, 120 and the hook portion 122, 124. In one embodiment, the hook portions are blocks essentially orthogonal to the vertical members 118, 120. This allows the user to lift objects, such as toilets, that have planar flanges that may be engaged for lifting. The horizontal and vertical members are preferably made of a tubular material for weight savings. The hook portions 122, 124 may include opposing blocks configured to releasably clamp to the flange of the object to be lifted.

Referring to FIG. 2, in one embodiment, the lifting component is pivotally coupled to one of the beams 108, 106 with a lifting arm 114. That is, the lifting arm 114 has a vertical aperture therein for the threaded rod 112 to pass and engages the threaded collar 110. Moreover, the lifting arm 114 may include a lateral aperture for the beam 108 to pass through, such that moving arm 114 up or down, as shown, causes a pivotal movement of the arm 114 about the axis of the beam 108, while also causing slight vertical movements in the threaded rod 112, when, as in this embodiment, the threaded rod 112 passes through both the beam 108 and the arm 114. In this embodiment, lifting of the object is independent of the lifting imparted by the lifting component 112. In other embodiments, the threaded rod may pass through the arm 114 more proximally or distally from the beam 108, for proportionally greater vertical movements, as is understood based on the disclosure. This configuration allows users to press on the arm 114, for example, to break any seal holding the appliance to be lifted to the floor, with no effect on the lifting by the lifting component 112.

In practice, the user may set up the apparatus 100 around the object to be lifted (i.e., with the object between the legs of the apparatus), lower the lifting component, by unscrewing the threaded collar 110 relative to the threaded rod 112, placing the hooks 122, 124 about the object to be lifted, securing the hooks 122, 124 to the object, and raising the lifting assembly by screwing the threaded collar 110 into the threaded rod 112, thereby reducing the length of the threaded rod 122 exposed and correspondingly raising the contact portion and the object attached thereto. As the lifting assembly encounters resistance, the user may operate the lifting arm 114 to further lift the object. This unengaged movement allows the user to not only lift, but also release pressure, for example, if the object is adhered to the floor, while tension is held by the lifting assembly. While in tension, the user may attempt to cut any adhesive between the object and the floor, beneficially without having to bear the weight of the object. Once released, the object may be lifted sufficiently for the user to work underneath the object, for example, to replace the wax ring of the toilet. The object may be replaced by reversing the steps noted herein.

While the foregoing invention has been described in some detail for purposes of clarity and understanding, it will be appreciated by one skilled in the art, from a reading of the disclosure, that various changes in form and detail can be made without departing from the true scope of the invention.

What is claimed is:

1. A lifting apparatus, comprising:
a first frame and a second frame, the first frame horizontally opposed from the second frame;
at least one beam interconnecting a top portion of the horizontally opposed first and second frames;
a lifting assembly coupled to the at least one beam, the lifting assembly comprising a lifting arm, a contact portion configured to engage an object to be lifted, and a lifting component, the contact portion functionally coupled to the at least one beam with the lifting component, the lifting component pivotally coupled to the at least one beam with the lifting arm, wherein actuating the lifting arm lifts and raises the object independent of the raising and lowering of the object with the lifting component.

2. The apparatus of claim 1, wherein at least one of the frames further comprises wheels for facilitating movement of the apparatus.

3. The apparatus of claim 2, wherein the frames, the strut and the beams are constructed from a material selected from the group consisting of steel and aluminum.

4. The apparatus of claim 1, wherein each of the first and second frames comprises a plurality of legs pivotally coupled to a block, and a strut connecting the plurality of legs of each of the first and second frame to form an A-shape configuration.

5. The apparatus of claim 1, wherein the lifting component comprises a threaded rod, a threaded collar, a contact portion coupled to the threaded rod, wherein a distal end of the lifting arm has a horizontal aperture and a vertical aperture, the at least one beam passes through the horizontal aperture, wherein the threaded rod passes through the vertical aperture, and wherein lifting of the contact portion is caused by threading the threaded collar to shorten an exposed length of the threaded rod.

6. The apparatus of claim 1, wherein the contact portion comprises a horizontal member and a plurality of hooks pivotally coupled thereto.

7. The apparatus of claim 6, wherein each hook comprises a vertical member.

8. The apparatus of claim 7, wherein the hook portions further comprises blocks orthogonal to the vertical members.

9. A method for lifting an object with a lifting apparatus, the lifting apparatus comprising:
a first frame and a second frame, the first frame horizontally opposed from the second frame;
at least one beam interconnecting a top portion of the horizontally opposed first and second frames;
a lifting assembly coupled to the at least one beam, the lifting assembly comprising a lifting arm, a contact portion configured to engage an object to be lifted, and a lifting component, the contact portion functionally coupled to the at least one beam with the lifting component, the lifting component pivotally coupled to the at least one beam with the lifting arm, wherein actuating the lifting arm lifts and raises the object independent of the raising and lowering of the object with the lifting component; the method comprising:
placing an object between the first and second frame;
securing the object to the lifting assembly with the contact portion; and
actuating the lifting arm to move the object independent of the lifting component.

10. The method of claim 9, wherein at least one of the frames further comprises wheels for facilitating movement of the apparatus.

11. The method of claim 10, wherein the frames, the strut and the beams are constructed from a material selected from the group consisting of steel and aluminum.

12. The method of claim 9, wherein each of the first and second frames comprises a plurality of legs pivotally coupled to a block, and a strut connecting the plurality of legs of each of the first and second frame to form an A-shape configuration.

13. The method of claim 9, wherein the lifting component comprises a threaded rod, a threaded collar, a contact portion coupled to the threaded rod, wherein a distal end of the lifting arm has a horizontal aperture and a vertical aperture, the at least one beam passes through the horizontal aperture, wherein the threaded rod passes through the vertical aperture, and wherein lifting of the contact portion is caused by threading the threaded collar to shorten an exposed length of the threaded rod.

14. The method of claim 9, wherein the contact portion comprises a horizontal member and a plurality of hooks pivotally coupled thereto.

15. The method of claim 14, wherein each hook comprises a vertical member.

16. The method of claim 15, wherein the hook portions further comprises blocks orthogonal to the vertical members.
